(19) United States
(12) Patent Application Publication
(10) Pub. No.: US 2009/0106798 A1
(43) Pub. Date: Apr. 23, 2009

(54) CHARACTER STRING RECEIVING DEVICE, CHARACTER STRING TRANSFERRING DEVICE, CHARACTER STRING TRANSMITTING/RECEIVING SYSTEM, CONTENT RECEIVING TERMINAL-SPECIFIC SYSTEM LSI, NAME LIST SHARING SYSTEM, NAME LIST SHARING METHOD, AND CONTENT RECOMMENDING METHOD

(76) Inventors: Hideaki NABATANI, Osaka (JP); Shirou YOSHIOKA, Hyogo (JP)

Correspondence Address: MCDERMOTT WILL & EMERY LLP, 600 13TH STREET, NW, WASHINGTON, DC, 20005-3096, US

(21) Appl. No.: 12/253,705

(22) Filed: Oct. 17, 2008

(30) Foreign Application Priority Data
Oct. 18, 2007 (JP) 2007-271710

(51) Int. Cl. H04N 5/445; G06F 17/21

(52) U.S. Cl. 725/46; 704/10

(57) ABSTRACT

A character string receiving device includes a reception unit for receiving character string data indicating a character string via unidirectional communication, and a character string processing unit for processing the character string data received by the reception unit.

### CROSS REFERENCE TO RELATED APPLICATIONS

This Non-provisional application claims priority under 35 U.S.C. §119(a) on Patent Application No. 2007-271710 filed in Japan on Oct. 18, 2007, the entire contents of which are hereby incorporated by reference.

### BACKGROUND OF THE INVENTION

1. Field of the Invention

The present invention relates to a technique of sharing information between a plurality of apparatuses by transferring the information bidirectionally or unidirectionally.

2. Description of the Related Art

Conventionally, a Japanese-language input system that employs a user's dictionary on a network has been used.

For example, Japanese Unexamined Patent Application Publication No. 2005-258888 (pp. 4-5, FIG. 1) discloses a network system in which a server receives unregistered words to which word conversion has been performed by mobile terminals, registers into a dictionary one or some of the received unregistered words that have been frequently used, and distributes to the mobile terminals the dictionary in which the unregistered words have been registered. Thus, the server can automatically collect and distribute unregistered words.

Japanese Unexamined Patent Application Publication No. H11-3330 (p. 2, FIG. 1) discloses a Japanese-language input system in which a kana-to-kanji conversion dictionary published on the Internet is downloaded by dictionary downloading means, and a kana-to-kanji conversion server uses the downloaded dictionary.

Conventionally, an address book sharing system has been used in which an address book is shared by a terminal and a server that are connected to each other via a communication channel (see, for example, Japanese Unexamined Patent Application Publication No. 2006-309590).

Japanese Unexamined Patent Application Publication No. 2007-36611 discloses a communication system in which data obtained by encrypting address information is transmitted from a mobile telephone to a public television telephone using an electronic phone book data in the mobile terminal.

### SUMMARY OF THE INVENTION

Recently, an increasing number of video apparatuses, audio apparatuses and the like have been provided with a Japanese-language input function. However, these apparatuses are typically not connected to a network, taking cost and ease of use into consideration. Therefore, a user's dictionary or a registered word that is frequently used for Japanese-language input cannot be shared by identical apparatuses, much less different apparatuses. Therefore, a storage unit for storing a user's dictionary or a registered word needs to be individually provided and a new word needs to be registered into the user's dictionary or the like in each individual storage unit.

Most of interfaces for directly inputting a character string into these video apparatuses, audio apparatuses and the like are difficult to operate, and large cost is required to cause these interfaces to be easy to use.

In view of the problems described above, an object of the present invention is to allow a user's dictionary or a registered word to be shared by a plurality of apparatuses while suppressing cost. Another object of the present invention is to make it easier to input a character string of Japanese language or the like into a video apparatus, an audio apparatus or the like while suppressing cost.

By using the techniques described in Japanese Unexamined Patent Application Publication Nos. 2006-309590 and 2007-36611, an address book can be easily shared by a mobile telephone and a personal computer. Thereby, addresses can be printed on new-year cards using the shared address book.

Incidentally, on the Internet, moving images are distributed after being processed so that they cannot be viewed unless a commercial is viewed, for example. Thereby, a provider of moving image data can secure income. Also, distribution of television broadcast contents on the Internet is currently under consideration.

Therefore, another object of the present invention is to promote viewing of moving images distributed on the Internet.

To achieve the objects, a first aspect of the present invention is directed to a character string receiving device includes a reception unit for receiving character string data indicating a character string via unidirectional communication, and a character string processing unit for processing the character string data received by the reception unit.

In the character string receiving device of the first aspect, character string data is received by the reception unit via unidirectional communication. Therefore, if character string data is transmitted to the character string receiving device, the character string receiving device and a transmitter apparatus can share the character string data without providing an apparatus for bidirectional communication. Also, since the character string receiving device includes the reception unit for receiving character string data, character string data can be transmitted and input to the character string reception unit without providing an interface with which a user performs a direct input in the character string receiving device.

According to a second aspect of the present invention, in the character string receiving device of the first aspect, the reception unit receives the character string data via infrared communication.

According to a third aspect of the present invention, in the character string receiving device of the first aspect, the character string data indicates at least one first character string and at least one second character string in association with each other, and the character string processing unit includes a user's dictionary storing unit for storing a user's dictionary for use in kana-to-kanji conversion, and registers the first and second character strings indicated by the character string data into the user's dictionary stored in the user's dictionary storing unit, as character strings before and after the conversion, in association with each other.

With the character string receiving device of the third aspect, character string data is transmitted to the character string receiving device, thereby making it possible to allow the same character string to be registered in a user's dictionary of the character string receiving device and a user's dictionary of a transmitter apparatus. Therefore, a plurality of apparatus can be caused to share a user's dictionary with low cost.

According to a fourth aspect of the present invention, the character string receiving device of the first aspect further includes a display unit for displaying a character string. The character string displayed by the display unit can be edited by a user. The character string processing unit inserts the character string indicated by the character string data into the character string displayed by the display unit that is being edited.

With the character string receiving device of the fourth aspect, character string data is transmitted to the character string receiving device, thereby making it possible to insert a character string indicated by the character string data into a character string displayed by a display unit that is being edited.

According to a fifth aspect of the present invention, in the character string receiving device of the first aspect, the reception unit further receives a command for instructing the character string receiving device to perform an operation corresponding to an input operation of a user.

With the character string receiving device of the fifth aspect, it is not necessary to provide a reception unit for receiving a command in the character string receiving device, apart from the reception unit for receiving character string data.

According to a sixth aspect of the present invention, in the character string receiving device of the first aspect, the character string processing unit includes a registered word storing unit for recording a list of registered words, or the character string receiving device includes a display unit for displaying a character string. The character string data is character string data for a user's dictionary indicating character strings before and after kana-to-kanji conversion in association with each other. The character string processing unit registers one of the character strings before and after the conversion indicated by the character string data, into the list stored in the registered word storing unit, or inserts a character string displayed by the display unit.

According to a seventh aspect of the present invention, in the character string receiving device of the first aspect, the character string processing unit includes a registered word storing unit for recording a list of registered words, or the character string receiving device includes a display unit for displaying a character string. The character string data is character string data for a user's dictionary indicating character strings before and after kana-to-kanji conversion in association with each other. The character string processing unit includes a user's dictionary storing unit for storing a user's dictionary for use in kana-to-kanji conversion, and operates in a plurality of modes including a user's dictionary registration mode. The character string processing unit, when operating in the user's dictionary registration mode, registers the character strings before and after the conversion indicated by the character string data, into the user's dictionary stored in the user's dictionary storing unit. The character string processing unit, when operating in a mode other than the user's dictionary registration mode, registers one of the character strings before and after the conversion indicated by the character string data, into the list stored in the registered word storing unit, or inserts one of the character strings before and after the conversion indicated by the character string data, into a character string displayed by the display unit.

An eight aspect of the present invention is directed to a character string transferring device including a transmission/reception unit for transmitting and receiving transmission/reception character string data indicating a character string via bidirectional communication, and a transmission unit for transmitting transmission character string data indicating a character string via unidirectional communication.

With the character string transferring device of the eighth aspect, the transmission unit can transmit transmission character string data to a character string receiving device that can receive data via unidirectional communication and cannot perform bidirectional communication. Therefore, a character string receiving device that can receive data via unidirectional communication and cannot receive data via bidirectional communication, and a character string transferring device can be allowed to share character string data with low cost.

According to a ninth aspect of the present invention, the character string transferring device of the eighth aspect, further includes a user's dictionary storing unit for storing a user's dictionary for registering character strings before and after kana-to-kanji conversion in association with each other. The transmission character string data indicates the character strings before and after the conversion registered in the user's dictionary.

With the character string transferring device of the ninth aspect, the transmission unit can transmit transmission character string data indicating registration into a user's dictionary, to a character string receiving device that can receive data via unidirectional communication and cannot perform bidirectional communication. Therefore, a receiver-side character string receiving device and a character string transferring device can be easily allowed to share a user's dictionary with low cost.

According to a tenth aspect of the present invention, in the character string transferring device of the eighth, the transmission/reception unit transmits and receives the transmission/reception character string data using a telephone line or a LAN line.

According to an eleventh aspect of the present invention, in the character string transferring device of the eighth, the transmission unit transmits the transmission character string data via infrared communication.

A twelfth aspect of the present invention is directed to a character string transmitting/receiving system includes the character string transferring device of the eighth aspect and the character string receiving device of the first aspect. The reception unit of the character string receiving device receives the transmission character string data transmitted by the transmission unit of the character string transferring device. The character string transferring device further includes a user's dictionary storing unit for storing a user's dictionary for registering character strings before and after kana-to-kanji conversion in association with each other. The transmission character string data indicates the character strings before and after the conversion registered in the user's dictionary.

A thirteenth aspect of the present invention is directed to a content receiving terminal-specific system LSI for use in a content receiving terminal capable of transmitting content information about a recommended content and an apparatus ID of the content receiving terminal to a mail receiving terminal having a mail address. The content receiving terminal-specific system LSI includes a name list storing unit for storing a name list indicating a name and an apparatus ID of a person in association with each other, an infrared receiving unit for receiving data indicating a content of a name list indicating a name and a mail address of a person in association with each other, via infrared communication, and a mail address adding unit for adding a name and a mail address of a person whose name is not included in the name list stored in the name list storing unit, of the name list indicated by data received by the infrared receiving unit, to the name list stored in the name list storing unit in association with each other, and further adding a mail address of a person whose name is included in the name list stored in the name list storing unit, of the name list indicated by the data, to the name list stored in the name list storing unit, in association with the name of the person.

With the content receiving terminal-specific system LSI of the thirteenth aspect, the content receiving terminal can transmit content information about a predetermined recommended content and an apparatus ID of itself to a mail receiving terminal having a mail address indicated by data received by the infrared receiving unit. Thereby, a user of the mail receiving terminal, when viewing the content indicated by the received content information, can input the apparatus ID transmitted along with the content information to a content receiving terminal of itself Therefore, a new service can be provided, e.g., when the content receiving terminal that has received the apparatus ID informs a server or the like that viewing has been performed in accordance with content information from a content receiving terminal that is a source of the content information, a user of the content receiving terminal that is a source of the content information or a user of the content receiving terminal in which viewing has been performed gets cashback.

A fourteenth aspect of the present invention is directed to a name list sharing system including the content receiving terminal-specific system LSI of thirteenth, and a mobile telephone-specific system LSI including a name list storing unit for storing a name list indicating a name and a mail address of a person in association with each other, and an infrared transmitting unit for transmitting data indicating a content of the name list stored in the name list storing unit, to a content receiving terminal including the content receiving terminal-specific system LSI, via infrared communication.

A fifteenth aspect of the present invention is directed to a name list sharing method including a first step in which a first apparatus having a name list storing unit for storing a first name list indicating a name and a mail address of a person in association with each other, transmits data indicating a content of the first name list via infrared communication, a second step in which a second apparatus having a name list storing unit for storing a second name list indicating a name and an apparatus ID of a person in association with each other and capable of transmitting content information indicating a recommended content and an apparatus ID of the second apparatus, to a mail receiving terminal having a mail address, receives the data transmitted by the first apparatus in the first step, and a third step in which the second apparatus adds a name and a mail address of a person whose name is not included in the second name list, of the first name list indicated by the data received in the second step, to the second name list in association with each other, and further adds a mail address of a person whose name is included in the second name list, of the first name list, to the second name list in association with the name of the person.

With the name list sharing method of the fifteenth aspect, the second apparatus can transmit content information about a predetermined recommended content and an apparatus ID of itself to a mail receiving terminal having a mail address added in the third step. Thereby, a user of the mail receiving terminal, when viewing the content indicated by the received content information, can input the apparatus ID transmitted along with the content information to a content receiving terminal of itself. Therefore, a new service can be provided, e.g., when the content receiving terminal that has received the apparatus ID informs a server or the like that viewing has been performed in accordance with content information from the second device that is a source of the content information, a user of the second device or a user of the content receiving terminal in which viewing has been performed gets cashback.

According to a sixteenth aspect of the present invention, the name list sharing method of the fifteenth aspect, further includes a fourth step in which the second apparatus transmits a name and an apparatus ID of a person indicated by the second name list in association with each other, to the first apparatus via infrared communication, a fifth step in which the first apparatus receives the data transmitted by the second apparatus in the fourth step, and a sixth step in which the first apparatus adds the name and apparatus ID of the person indicated by the data received in the fifth step in association with each other, to the first name list in association with each other.

A seventeenth aspect of the present invention is directed to a content recommending method including a first step in which a content information distributing apparatus having a name list storing unit for storing a name list indicating a name and an apparatus ID of a person in association with each other, transmits content information indicating a recommended content to a content receiving terminal having an apparatus ID indicated by the name list in association with a name of a person designated by an input, and a second step in which the content receiving terminal receives the content information transmitted in the first step, and displays the recommended content indicated by the received content information.

With the content recommending method of the seventeenth aspect, a user of a content receiving terminal can view a recommended content based on content information received by the content receiving terminal.

An eighteenth aspect of the present invention is directed to a content recommending method including a first step in which a content information distributing apparatus having a name list storing unit for storing a name list indicating a name and a mail address of a person in association with each other, transmits content information indicating a recommended content designated by an input and an apparatus ID of the content information distributing apparatus, to a mail receiving terminal having a mail address indicated by the name list in association with a name of a person designated by an input, and a second step in which the mail receiving terminal receives the content information and the apparatus ID transmitted in the first step, and displays the recommended content indicated by the received content information and the apparatus ID.

With the content recommending method of the eighteenth aspect, a user of the mail receiving terminal, when viewing a content indicated by received content information, can input an apparatus ID displayed along with the content information, to a content receiving terminal of itself Therefore, a new service can be provided, e.g., when the content receiving terminal that has received the apparatus ID informs a server or the like that viewing has been performed in accordance with content information from the content information distributing apparatus that is a source of the content information, a user of the content information distributing apparatus or a user of the content receiving terminal in which viewing has been performed gets cashback.

### BRIEF DESCRIPTION OF THE DRAWINGS

FIG. 1 is a block diagram showing a configuration of a network system according to Embodiment 1 of the present invention.

FIG. 2 is a block diagram showing a configuration of a DVD recorder 100 in the network system of Embodiment 1.

FIG. 3 is a block diagram showing a configuration of a mobile telephone 200 in the network system of Embodiment 1.

FIG. 4 is a diagram for describing a format of unidirectional communication data for use in unidirectional infrared communication in the network system of Embodiment 1.

FIG. 5 is a diagram for describing an image displayed by a display unit 103 and a display unit 206 when the DVD recorder 100 is in a character string input mode in the network system of Embodiment 1.

FIG. 6 is a diagram for describing an image displayed by the display unit 103 and the display unit 206 when the DVD recorder 100 is in a registered word input mode in the network system of Embodiment 1.

FIG. 7 is a diagram for describing an image displayed by the display unit 103 and the display unit 206 when the DVD recorder 100 is in a character string input mode in the network system of Embodiment 1.

FIG. 8 is a diagram for describing an image displayed by the display unit 103 and the display unit 206 when the DVD recorder 100 is in a user's dictionary registration mode in the network system of Embodiment 1.

FIG. 9 is a diagram for describing an image displayed by the display unit 103 and the display unit 206 when the DVD recorder 100 is in a registered word input mode in the network system of Embodiment 1.

FIG. 10 is a diagram for describing an image displayed by the display unit 103 and the display unit 206 when the DVD recorder 100 is in a character string input mode in the network system of Embodiment 1.

FIG. 11 is a block diagram showing a configuration of a network system according to Embodiment 2 of the present invention.

FIG. 12 is a block diagram showing a configuration of a DVD recorder 1100 in the network system of Embodiment 2.

FIG. 13 is a block diagram showing a configuration of a mobile telephone 1200 in the network system of Embodiment 2.

FIG. 14 is a diagram for describing a data structure of an address book stored in an address book storing unit 1112 or the like in the network system of Embodiment 2.

FIG. 15 is a diagram for describing a format of unidirectional communication data for use in unidirectional infrared communication in the network system of Embodiment 2.

FIG. 16 is a flowchart showing an operation in which the DVD recorder 1100 and the mobile telephone 1200 share an address book in the network system of Embodiment 2.

FIGS. 17A to 17D are diagrams for describing the contents of an address book stored in an address book stored in an address book storing unit 1212 and an address book stored in an address book storing unit 1112 in the network system of Embodiment 2.

FIG. 18 is a flowchart showing an operation of the DVD recorder 1100 and a DVD recorder 1160 when a new service employing an address book prepared by the procedure of FIG. 16 is performed in the network system of Embodiment 2.

FIGS. 19A and 19B are diagrams for describing display screens of a television connected to the DVD recorder 1100 and a television connected to the DVD recorder 1160 in the network system of Embodiment 2.

FIG. 20 is a flowchart showing an operation of the DVD recorders 1100 and 1160 when another new service is performed, in the network system of Embodiment 2.

FIGS. 21A to 21C are diagrams for describing display screens of a television connected to the DVD recorder 1100, a television connected to the DVD recorder 1160, and a mobile telephone, in the network system of Embodiment 2.

### DETAILED DESCRIPTION OF THE PREFERRED EMBODIMENTS

Hereinafter, embodiments of the present invention will be described with reference to the accompanying drawings. Like parts are indicated by like reference numerals throughout the specification.

### Embodiment 1

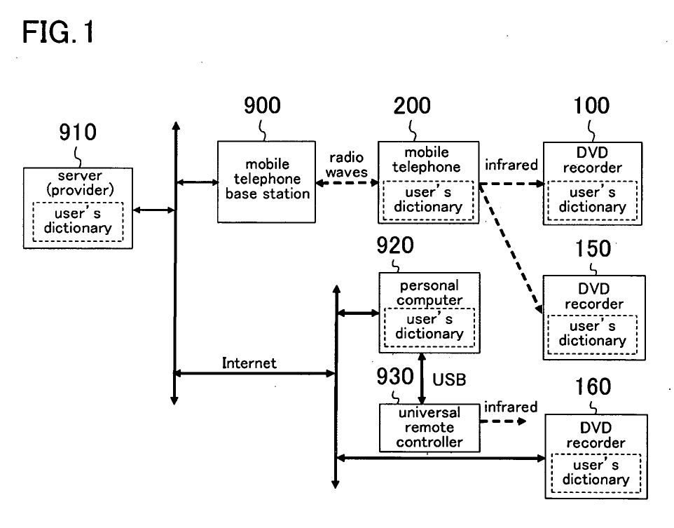

As shown in FIG. 1, a network system (character string transmitting/receiving system) according to Embodiment 1 of the present invention includes a Digital Versatile Disc (DVD) recorders 100, 150 and 160, a mobile telephone 200, a mobile telephone base station 900 for enabling voice and data communication via radio waves of the mobile telephone 200, an Internet provider server 910, a personal computer 920 that can be connected to the Internet, and a universal remote controller 930 connected via a Universal Serial Bus (USB) to the personal computer 920.

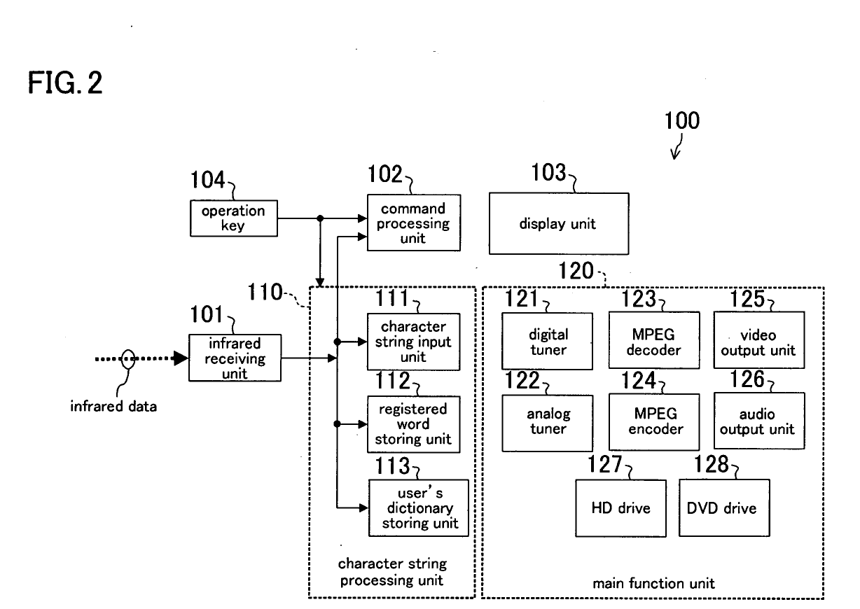

As shown in FIG. 2, a DVD recorder (character string receiving device) 100 comprises an infrared receiving unit (reception unit) 101 for receiving infrared data, a command processing unit 102 for processing data indicating a command of the infrared data received by the infrared receiving unit 101, a character string processing unit 110 for processing data indicating a character string (character string data) of the infrared data, a display unit 103 for displaying various pieces of information, an operation key 104 for performing a key input operation, and a main function unit 120 for performing a main function of the DVD recorder 100.

The character string processing unit 110 comprises a character string input unit 111 for inserting a character string indicated by infrared data received by the infrared receiving unit 101 into a character string displayed by the display unit 103 during a character string input state, a registered word storing unit 112 for storing the contents of a list in which a frequently used word is registered, and a user's dictionary storing unit 113 for storing the contents of a user's dictionary in which character strings before and after kana-to-kanji conversion for a frequently used word are registered in association with each other. The user causes the display unit 103 to display the word list stored in the registered word storing unit 112 by a predetermined input, selects a word from the displayed list, and inserts the selected word into a character string that is displayed by the display unit 103 and is being edited. The user's dictionary is used for kana-to-kanji conversion in a Japanese-language input system. In the user's dictionary, character strings before and after kana-to-kanji conversion are registered in a one-to-one correspondence with each other. For example, [symbol] that is a character string before conversion and [symbol] that is a character string after conversion are registered in association with each other. Also, in the user's dictionary, a standard phrase that has a long string length for inputting and a portion of the kana pronunciation thereof that has a short string length are registered in association with each other. For example, a pre-conversion character string [symbol] and a post-conversion character string [symbol] are registered in association with each other.

The DVD recorder 100 operates in three modes, i.e., a character string input mode, a registered word input mode, and a user's dictionary registration mode. When the DVD recorder 100 is in the character string input mode, the character string input unit 111 of the character string processing unit 110 inserts a character string indicated by infrared data received by the infrared receiving unit 101 into a character string displayed by the display unit 103. When the DVD recorder 100 is in the registered word input mode, the registered word storing unit 112 of the character string processing unit 110 registers a character string indicated by infrared data received by the infrared receiving unit 101 into the stored list. When the DVD recorder 100 is in the user's dictionary registration mode, the user's dictionary storing unit 113 of the character string processing unit 110 registers character strings before and after kana-to-kanji conversion that are indicated by infrared data received by the infrared receiving unit 101 into the stored user's dictionary.

The main function unit 120 comprises a digital tuner 121 for receiving a digital television broadcast, an analog tuner 122 for receiving an analog television broadcast, a Moving Picture Experts Group (MPEG) decoder 123 for decoding a received digital television broadcast, an MPEG encoder 124 for encoding a received analog television broadcast, a hard disk drive (HD drive) 127 for recording broadcast data, a DVD drive 128 for recording broadcast data, a video output unit 125, and a voice output unit 126.

The DVD recorder 150 has the same configuration and function as those of the DVD recorder 100. Whereas the DVD recorder 100 and the DVD recorder 150 are not configured to be connectable to the Internet, the DVD recorder 160 is configured to be connectable to the Internet.

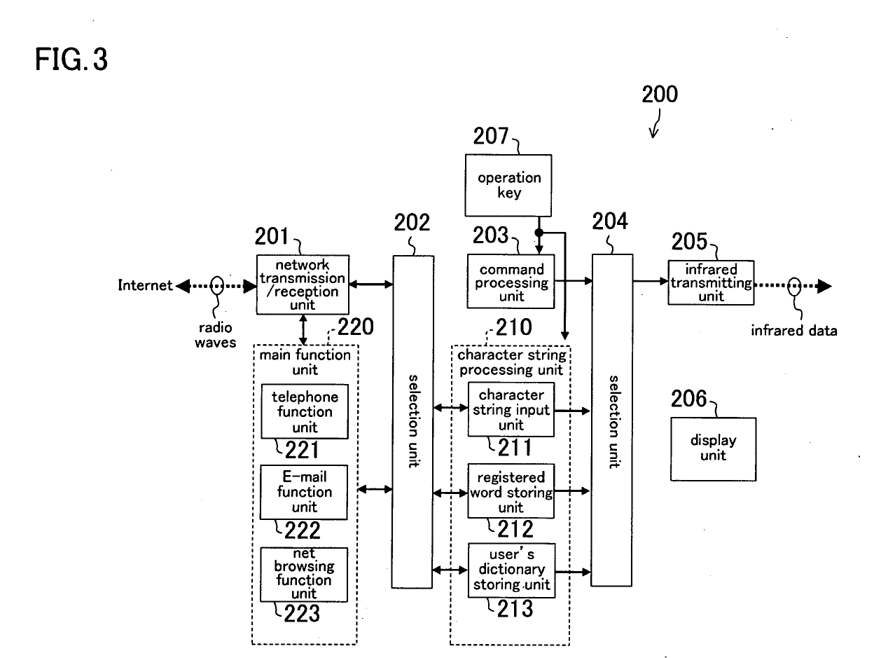

The mobile telephone 200 (character string transferring device) is configured to be connectable to the Internet. Specifically, as shown in FIG. 3, the mobile telephone 200 comprises a network transmission/reception unit 201 (transmission/reception unit), an infrared transmitting unit 205 (transmission unit), a display unit 206 for displaying various pieces of information, an operation key 207 for performing a key input operation, a character string processing unit 210 for processing a character string or a word, or a dictionary, a main function unit 220 having a main function of the mobile telephone 200, a command processing unit 203, and selection units 202 and 204.

The network transmission/reception unit 201 transmits and receives radio waves so as to perform Internet communication, i.e., bidirectional communication. More specifically, the network transmission/reception unit 201 transmits and receives character string data via Internet communication using a telephone line or a Local Area Network (LAN) line.

The command processing unit 203 generates a command for instructing the DVD recorder 100 to perform an operation corresponding to an input operation by a user on the operation key 207.

The selection unit 204 selects data indicating a character string, a registered word, or a dictionary word that is output from the character string processing unit 210, and transmits the data to the infrared transmitting unit 205.

The selection unit 202 selects data indicating a character string, a registered word, or a dictionary word as with the selection unit 204, and transmits the data to the network transmission/reception unit 201 or the like.

The character string processing unit 210 comprises a character string input unit 211 for transmitting data indicating a character string input from the operation key 207 to the outside, a registered word storing unit 212 for storing the contents of a list in which a frequently used word is registered, and a user's dictionary storing unit 213 for storing the contents of a user's dictionary in which a frequently used word is registered. This user's dictionary is used for kana-to-kanji conversion in a Japanese-language input system as with the user's dictionary stored in the user's dictionary storing unit 113. In this user's dictionary, character strings before and after kana-to-kanji conversion are registered in a one-to-one correspondence with each other.

The main function unit 220 comprises a telephone function unit 221 for performing a process of enabling voice conversation of the mobile telephone 200, an E-mail function unit 222 for performing a process for transmission/reception of E-mail, and a net browsing function unit 223 for enabling browsing of the Internet.

The server 910, the personal computer 920, and the DVD recorder 160 also each have a user's dictionary storing unit storing a user's dictionary in which a frequently used word for Japanese-language input is registered.

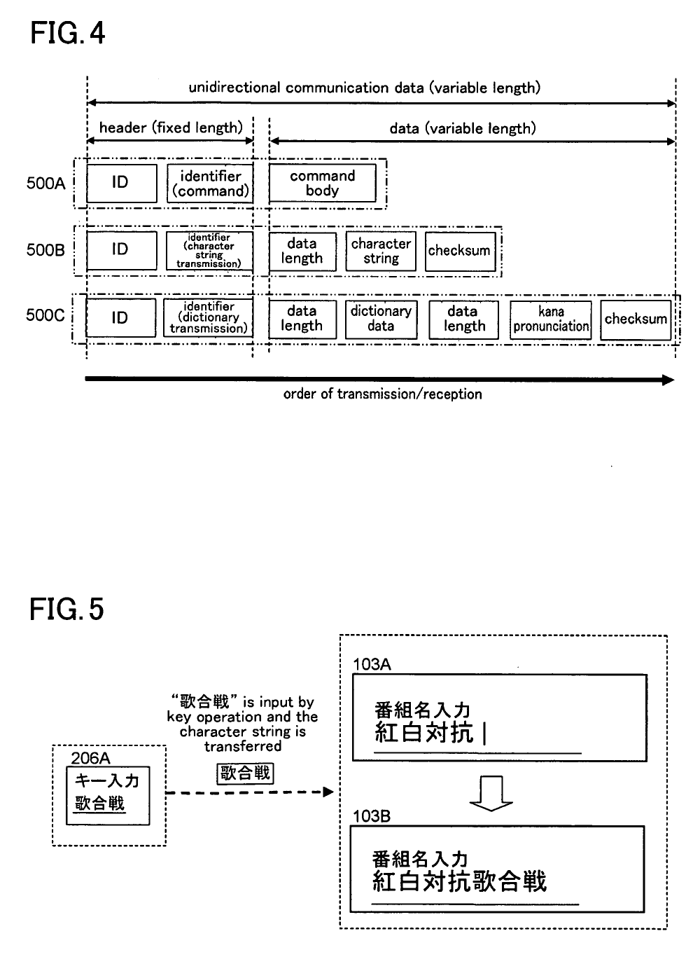

The infrared data received via infrared communication by the infrared receiving unit 101 of the DVD recorder 100 is in a format for unidirectional communication. Here, the unidirectional communication data format used in infrared unidirectional communication will be described with reference to FIG. 4. The unidirectional communication data used here has a variable length.

A format 500A is a commonly used format and is used so as to transmit a control command (instruction), such as switching of television channels for reception, play, stop and fast-forward of recorded video data, or the like, or a command of recording or the like. These commands are generated in the command processing unit 203 of the mobile telephone 200, depending on the input operation of a user. The format 500A is composed of a header having a fixed length including an identification (ID) for identifying an individual apparatus and an identifier for indicating command transmission, and data of a command body.

A format 500B is used so as to transmit a character string. More specifically, for example, the format 500B is used so as to insert a character string into a sentence or the like being edited in a mode in which a sentence string or a sentence is edited, or register a frequently used word. The format 500B is composed of a header having a fixed length including an ID for identifying an individual apparatus and an identifier for indicating transmission of a character string, and data having a variable length including a data length, data indicating a character string, and a checksum for checking an error in the data.

A format 500C is used so as to transmit dictionary data corresponding to one word. More specifically, the format 500C is used so as to register a word that is not included in a typical dictionary (not shown), but is frequently used, and its kana pronunciation into a user's dictionary. The format 500C is composed of a header having a fixed length including an ID for identifying an individual apparatus and an identifier for indicating transmission of one-word dictionary data, and data having a variable length including the data length of the dictionary data, the dictionary data, the data length of kana pronunciation data indicating a kana pronunciation, the kana pronunciation data, and a checksum for checking a data error.

Here, an operation of the network system of this embodiment will be described with reference to FIGS. 5 to 10.

Firstly, an operation when infrared data indicating a character string input to the mobile telephone 200 is transmitted to the DVD recorder 100, and the character string is inserted into a character string displayed by the display unit 103, will be described with reference to FIG. 5.

When the DVD recorder 100 is in the character string input mode (e.g., a program name edition mode), then if an operation is performed to input [symbol] to the operation key 207 of the mobile telephone 200, data indicating the character string [symbol] is temporarily stored in the character string input unit 211, and the display unit 206 displays what is shown by 206A in FIG. 5. Next, when a key for infrared transmission included in the operation key 207 is pressed, data indicating the character string [symbol] is input via the selection unit 204 to the infrared transmitting unit 205, which then transmits infrared data. The transmitted infrared data has the format 500B of FIG. 4. The infrared data includes a concatenation of an ID for the DVD recorder 100, a one-byte identifier indicating that communication data is a character string, one-byte data indicating the data length, data indicating the body of the character string, and a one-byte checksum for checking the presence or absence of an error during transfer, which are arranged in this stated order. Here, the ID indicates a manufacturer or a model. When a character string input to the mobile telephone 200 is [symbol] data indicating the body of the character string is six-byte data indicating [symbol] and therefore, a value indicating the length of the data is six.

The infrared data transmitted from the mobile telephone 200 is received by infrared receiving unit 101 in the DVD recorder 100, and is processed by the character string input unit 111 before being displayed by the display unit 103. As shown by 103A of FIG. 5, a character string [symbol] followed by a cursor is displayed by the display unit 103 before reception of the infrared data. It is here assumed that the displayed character string is being edited by a user. In this case, after the infrared data indicating the character string [symbol] is received, the character string is inserted at the position of the cursor, so that a character string [symbol] [symbol] is displayed as shown by 103B of FIG. 5. Specifically, the character string input unit 111 inserts the character string [symbol] into the character string [symbol] displayed by the display unit 103 that is being edited by the user.

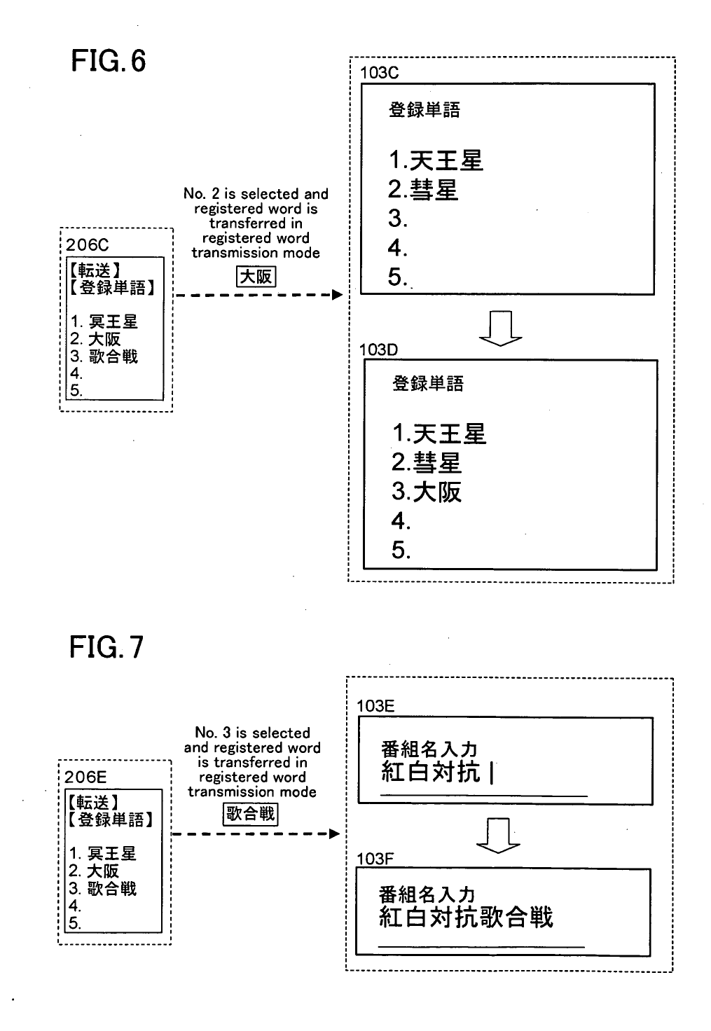

Next, an operation when infrared data indicating a word selected by a user of the registered words in the registered word storing unit 212 of the mobile telephone 200 is transmitted to the DVD recorder 100, and the word is registered into the list stored in the registered word storing unit 112, will be described with reference to FIG. 6.

When the DVD recorder 100 is in the registered word input mode, then if an operation of causing the mobile telephone 200 to display the list of registered words stored in the registered word storing unit 212 is performed, the display unit 206 of the mobile telephone 200 displays what is as shown by 206C of FIG. 6. Thereafter, when a user performs an operation of selecting the second character string [symbol] in the list with respect to the operation key 207 and then presses the infrared transmission key, data indicating the character string [symbol] is input via the selection unit 204 to the infrared transmitting unit 205, which then transmits infrared data. In this case, the infrared data has the format 500B of FIG. 4. There is not a difference in the format of communication data between when a character string to be inserted into a character string displayed by the display unit 103 is transmitted and when a registered word is transmitted. The DVD recorder 100 (receiver side) inserts the character string indicated by the communication data into a displayed character string or registers it, depending on the current setting, i.e., the current mode. The communication data is a concatenation of an ID for the DVD recorder 100, a one-byte identifier indicating that the communication data is a character string, one-byte data indicating the length of the data, data indicating the body of the character string, and a one-byte checksum for checking the presence or absence of an error during transfer, which are arranged in this stated order. Here, the ID indicates a manufacturer or a model. When an operation of selecting [symbol] is performed with respect to the mobile telephone 200, data indicating a character string body is four-byte data indicating [symbol] and therefore, a value indicating the data length is four.

Thereafter, the infrared data transmitted from the mobile telephone 200 is received by the infrared receiving unit 101 in the DVD recorder 100, and is processed by the registered word storing unit 112 before being displayed by the display unit 103. It is assumed that, before reception of the infrared data, as shown by 103C of FIG. 6, the first character string [symbol] and the second character string [symbol] are registered in the list stored in the registered word storing unit 112, and are displayed by the display unit 103. After infrared data indicating a character string [symbol] is received, [symbol] is newly registered at the third place in the list stored in the registered word storing unit 112, and is displayed by the display unit 103, as shown by 103D of FIG. 6.

Further, a case where infrared data indicating a word selected by a user of the registered words in the registered word storing unit 212 of the mobile telephone 200, is transmitted to the DVD recorder 100, and is inserted into a character string displayed by the display unit 103, will be described with reference to FIG. 7.

When the DVD recorder 100 is in the character string input mode, then an operation of displaying the list of registered words in the registered word storing unit 212 is performed in the mobile telephone 200, the display unit 206 of the mobile telephone 200 displays what is shown by 206E of FIG. 7. Thereafter, when a user performs an operation of selecting the third character string [symbol] from the list with respect to the operation key 207, and then presses the infrared transmission key, data indicating the character string [symbol] is input via the selection unit 204 to the infrared transmitting unit 205, which then transmits infrared data. In this case, the transmitted infrared data has the format 500B of FIG. 4. As described above, the infrared data is a concatenation of an ID, an identifier, one-byte data indicating the data length, data indicating the character string body, and a checksum, which are arranged in this stated order. When an operation of selecting [symbol] is performed with respect to the mobile telephone 200, data indicating the character string body is six-byte data indicating [symbol] and therefore, a value indicating the data length is six.

Thereafter, the infrared data transmitted from the mobile telephone 200 is received by the infrared receiving unit 101 in the DVD recorder 100, and is processed by the character string input unit 111 before being displayed by the display unit 103. If it is assumed that, before reception of the infrared data, a character string [symbol] followed by a cursor is displayed by the display unit 103 as shown by 103E of FIG. 7, then when infrared data indicating the character string [symbol] is received, the character string is inserted at the position of the cursor, so that a character string [symbol] [symbol] is displayed as shown by 103F of FIG. 7.

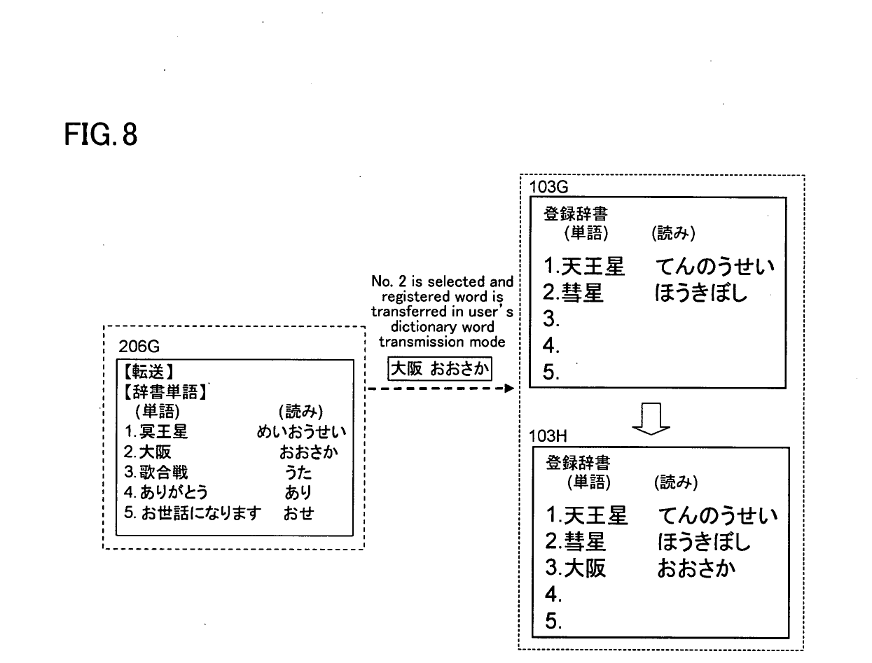

Further, an operation when infrared data indicating a word selected by a user of the dictionary words registered in the user's dictionary stored in the user's dictionary storing unit 213 of the mobile telephone 200 is transferred to the DVD recorder 100, and the word is registered into the user's dictionary stored in the user's dictionary storing unit 113, will be described with reference to FIG. 8.

When the DVD recorder 100 is in the user's dictionary registration mode, then if an operation of displaying the list of dictionary words registered in the user's dictionary stored in the user's dictionary storing unit 213 of the mobile telephone 200, is performed, the display unit 206 of the mobile telephone 200 displays what is as shown by 206G of FIG. 8. As described above, in the user's dictionary of the user's dictionary storing unit 213, not only a difficult kanji word or a frequently used word is registered, but also a standard phrase having a long string length for inputting can be registered in association with a portion of the kana pronunciation as shown in the fourth and fifth character strings of FIG. 8. When a user performs an operation of selecting the second character string [symbol] from the list with respect to the operation key 207 and presses the infrared transmission key, data indicating the character string [symbol] is input via the selection unit 204 to the infrared transmitting unit 205, which then transmits infrared data. In this case, the transmitted infrared data has the format 500C of FIG. 4. This format is a concatenation of an ID, an identifier, one-byte data indicating the data length of dictionary data indicating a dictionary word, the body of the dictionary data, one-byte data indicating the data length of kana pronunciation data indicating a kana pronunciation, the body of the kana pronunciation data, and a checksum, which are arranged in this stated order. In other words, the transmitted infrared data indicates a kana pronunciation that is a character string before kana-to-kanji conversion and a dictionary word that is a character string after kana-to-kanji conversion in association with each other. When an operation of selecting [symbol] is performed with respect to the mobile telephone 200, dictionary data indicating [symbol] is four-byte data, and therefore, a value indicating the data length is four. The kana pronunciation data is eight-byte data indicating [symbol] and a value indicating the data length is eight.

Thereafter, the infrared data transmitted from the mobile telephone 200 is received by the infrared receiving unit 101 in the DVD recorder 100, and is processed by the user's dictionary storing unit 113 before being displayed by the display unit 103. It is here assumed that, before reception of the infrared data, the display unit 103 displays only the first character string [symbol] (registered kana pronunciation: [symbol] and the second character string [symbol] (registered kana pronunciation: [symbol] which is different from the correct kana pronunciation [symbol] while only the first character string [symbol] and the second character string [symbol] are registered in the user's dictionary storing unit 113, as shown by 103G of FIG. 8. In this case, after infrared data including dictionary data indicating [symbol] and kana pronunciation data indicating [symbol] [symbol] are received, [symbol] and its kana pronunciation [symbol] are newly registered as pre-conversion and post-conversion character strings into the user's dictionary stored in the user's dictionary storing unit 113, and are displayed at the third place on the display unit 103, as shown by 103H of FIG. 8.

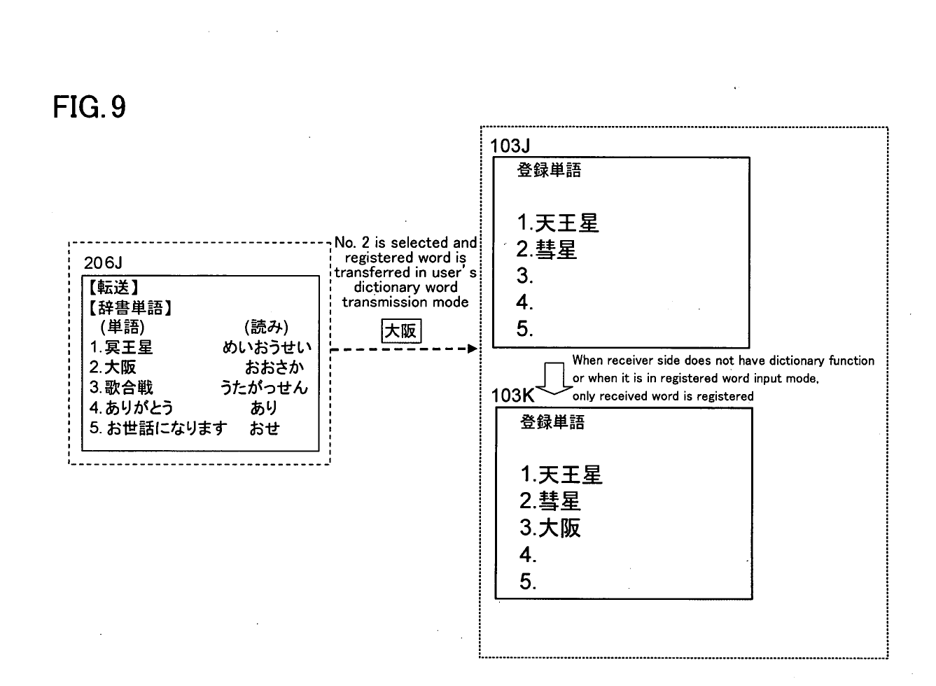

Further, an operation when infrared data indicating a word selected by a user of the dictionary words registered in the user's dictionary stored in the user's dictionary storing unit 213 of the mobile telephone 200, is transmitted to the DVD recorder 100, and the word is registered into the list stored in registered word storing unit 112, will be described with reference to FIG. 9.

When the DVD recorder 100 is in the registered word input mode, then if an operation of causing the mobile telephone 200 to display the list of dictionary words registered in the user's dictionary stored in the user's dictionary storing unit 213, is performed, the display unit 206 of the mobile telephone 200 displays what is as shown by 206J of FIG. 9. When a user performs an operation of selecting the second character string [symbol] from the list with respect to the operation key 207, and presses the infrared transmission key, data indicating [symbol] is input via the selection unit 204 to the infrared transmitting unit 205, which then transmits infrared data. In this case, the infrared data has the format 500C of FIG. 4. This format is used for communication of a dictionary word. This format is a concatenation of an ID, an identifier, one-byte data indicating the data length of dictionary data indicating a dictionary word, the body of the dictionary data, one-byte data indicating the data length of kana pronunciation data indicating a kana pronunciation, the body of the kana pronunciation data, and a checksum, which are arranged in this stated order. When an operation of selecting [symbol] is performed with respect to the mobile telephone 200, dictionary data indicating [symbol] is four-byte data, and a value of the data length is four. The kana pronunciation data indicating [symbol] [symbol] is eight-byte data, and therefore, a value indicating the data length is eight.

Thereafter, the infrared data transmitted from the mobile telephone 200 is received by the infrared receiving unit 101 of the DVD recorder 100, and is processed by the registered word storing unit 112 before being displayed by the display unit 103. Here, since the infrared data is processed by the registered word storing unit 112, the kana pronunciation data is ignored and abandoned. It is here assumed that, before reception of the infrared data, the first character string [symbol] and the second character string [symbol] are registered in the list stored in the registered word storing unit 112 as shown by 103J of FIG. 9, and are displayed by the display unit 103. In this case, after the infrared data indicating the character string [symbol] is received, [symbol] is registered at the third place in the list stored in the registered word storing unit 112, and is displayed by the display unit 103, as shown in 103k of FIG. 9.

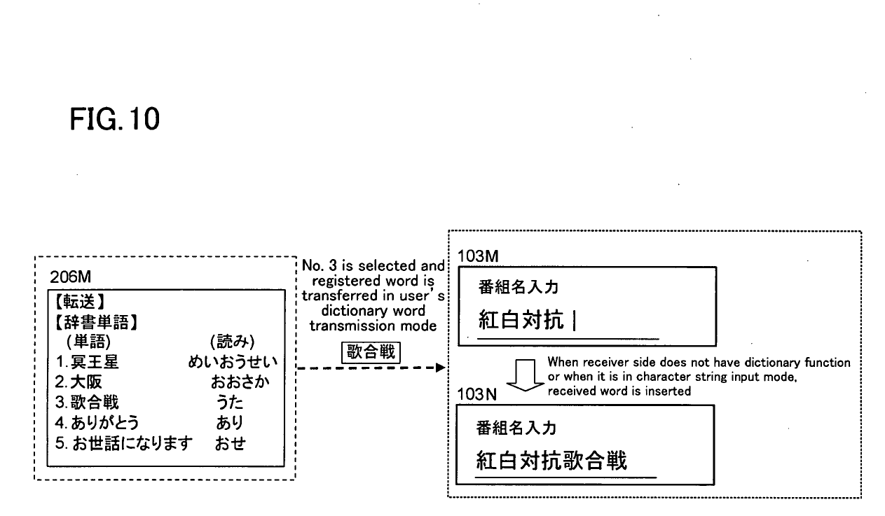

Moreover, an operation when infrared data indicating a word selected by a user of the dictionary words registered in the user's dictionary stored in the user's dictionary storing unit 213 of the mobile telephone 200, is transmitted to the DVD recorder 100, and is then inserted into a character string displayed by the display unit 103, will be described with reference to FIG. 10.

When the DVD recorder 100 is in the character string input mode, then if an operation of displaying the list of dictionary words registered in the user's dictionary stored in the user's dictionary storing unit 213 is performed with respect to the mobile telephone 200, the display unit 206 of the mobile telephone 200 displays what is as shown by 206M of FIG. 10. When a user performs an operation of selecting the third character string [symbol] from the list with respect to the operation key 207, and presses the infrared transmission key, data indicating [symbol] is input via the selection unit 204 to the infrared transmitting unit 205, and infrared data is transmitted to the infrared transmitting unit 205. In this case, the transmitted infrared data has the format 500C of FIG. 4. This format is, as described above, a concatenation of an ID, an identifier, one-byte data indicating the data length of dictionary data indicating a dictionary word, the body of the dictionary data, one-byte data indicating the data length of kana pronunciation data indicating a kana pronunciation, the body of the kana pronunciation data, and a checksum, which are arranged in this stated order. When an operation of selecting [symbol] is performed with respect to the mobile telephone 200, dictionary data indicating [symbol] is six-byte data, and therefore, a value indicating the data length is six. The kana pronunciation data is four-byte data indicating [symbol] and a value indicating the data length is four.

Thereafter, the infrared data transmitted by the mobile telephone 200 is received by the infrared receiving unit 101 in the DVD recorder 100, and is processed by the character string input unit 111 before being displayed by the display unit 103. Since the infrared data is processed by the character string input unit 111, the kana pronunciation data is ignored and abandoned. It is here assumed that, in the display unit 103, a character string [symbol] followed by a cursor is displayed before reception of infrared data as shown by 103M of FIG. 10. In this case, after infrared data indicating the character string [symbol] is received, the character string is inserted at the position of the cursor, so that a character string [symbol] [symbol] is displayed as shown by 103N of FIG. 10.

As shown in FIG. 1, the mobile telephone 200, the server 910, the personal computer 920, and the DVD recorder 160 can be connected to the same network, so that they can share a user's dictionary or a displayed or registered character string. The mobile telephone 200, when connected to the Internet, can transfer and receive data to and from the server 910 via the mobile telephone base station 900. Also, the personal computer 920 and the DVD recorder 160 can be directly connected to the Internet, and therefore, can similarly transmit and receive data to and from the server 910. Specifically, the mobile telephone 200, the personal computer 920, and the DVD recorder 160 can transmit and receive data, such as a character string included in a user's dictionary, other character strings, and the like, via the server 910. The DVD recorder 100 and the DVD recorder 150 that are not connected to the Internet can be caused to have the same data, such as a character string included in a user's dictionary, other character strings, and the like, as those of other apparatuses via the mobile telephone 200 as described above. Thus, in this embodiment, a user's dictionary or a character string is shared by a plurality of apparatuses having different specifications.

Note that, in addition to the mobile telephone 200, another apparatus that can be connected to the Internet and has an infrared communication function may be used to achieve a similar effect. Also, as with the universal remote controller 930 of FIG. 1, an apparatus that can be connected to the Internet via another interface (i.e., a USB) and has an infrared communication function may be used to achieve a similar effect.

Thus, as described with reference to the operations of FIGS. 5 to 10, in the network system of this embodiment, character string data, such as a word included in a user's dictionary, other words or the like, is transmitted via infrared communication that is conventionally used only for remote controls, such as a power control, a play control, a stop control and the like, and the infrared data is received and processed. Therefore, in the DVD recorder 100 that is not connected to a network, such as the Internet or the like, the same Japanese-language character string or user's dictionary as that of an apparatus that can be connected to the network can be used, so that a Japanese-language input environment that is easy to use can be achieved.

Moreover, as shown in FIG. 1, the apparatus capable of both infrared communication and network connection transmits character string data as infrared data that is used for a remote controller. Therefore, data of a user's dictionary or a word on a network can be utilized by an apparatus that has a function of receiving infrared, but is not connected to the network. Also, the format of infrared data (the communication format of infrared communication) used in this embodiment is simple as shown in FIG. 4, so that the infrared data can be received by low-cost communication means. Also, even if data has poor compatibility, the data can be utilized to the extent possible to facilitate Japanese-language input.

Also, in the network system of this embodiment, as described with reference to the operations of FIGS. 7, 9 and 10, there are a plurality of operation states where a transmitter is in the registered word mode while a receiver is in the character string input mode, where a transmitter is in the dictionary word mode while a receiver is in the registered word mode, and where a transmitter is in the dictionary word mode while a receiver is in the character string input mode. Even if there are such a plurality of operation states, data, such as a user's dictionary or a word, can be utilized by a receiver flexibily performing a process with respect to data, depending on an operation state and a function possessed by the receiver.

Note that, in the user's dictionary of this embodiment, character strings before and after kana-to-kanji conversion are registered in a one-to-one correspondence with each other. However, the one-to-one correspondence is not necessarily required. For example, three character strings [symbol] and [symbol] that are post-conversion character strings for a pre-conversion character string [symbol] may be registered in association with [symbol] . Also, character strings [symbol] and [symbol] that are pre-conversion character strings for a post-conversion character string [symbol] may be registered in association with [symbol] .

Also, in the network system of this embodiment, the DVD recorders 100 and 150 each have the user's dictionary storing units 113 for storing a user's dictionary, and have a function of registering, into the user's dictionary, character strings before and after kana-to-kanji conversion corresponding to received infrared data. However, the DVD recorders 100 and 150 may not have a function of storing character strings before and after kana-to-kanji conversion in association with each other, and when receiving infrared data having the user's dictionary format 500C of FIG. 4, may register at least one of the character strings before and after conversion into the list stored in the registered word storing unit 112, or insert it into a character string displayed by the display unit 103.

Also, instead of the DVD recorders 100 and 150, other video apparatuses or audio apparatuses that can receive infrared data and perform Japanese-language input may be used. Instead of the mobile telephone 200, other apparatuses that can be connected to the Internet and can transmit infrared data and perform Japanese-language input may be used.

### Embodiment 2

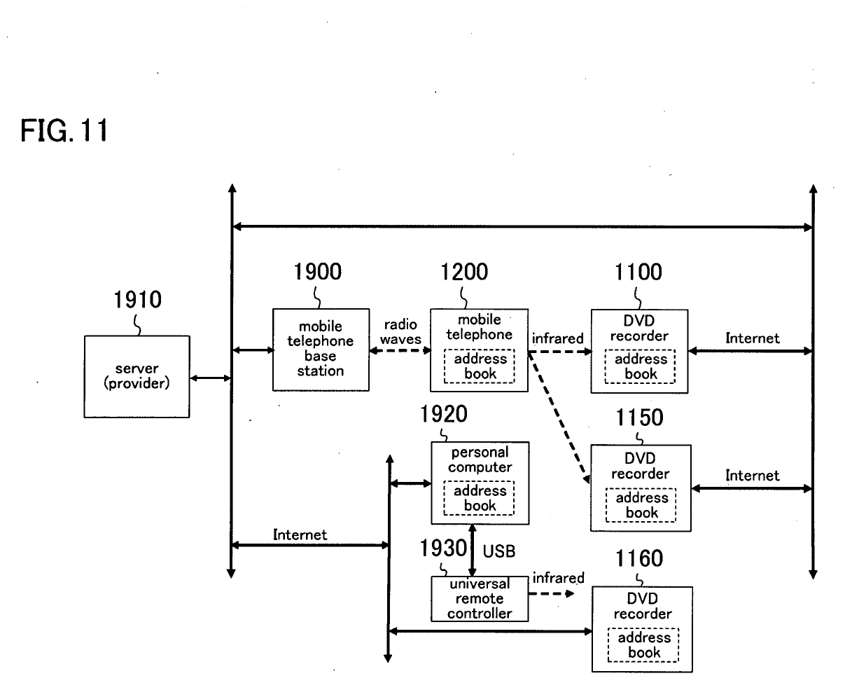

As shown in FIG. 11, a network system according to Embodiment 2 of the present invention includes DVD recorders 1100, 1150 and 1160, a mobile telephone 1200, a mobile telephone base station 1900 for enabling voice and data communication via radio waves of the mobile telephone 1200, an Internet provider server 1910, a personal computer (personal computer) 1920 that can be connected to the Internet, and a universal remote controller 1930 connected via a USB to the personal computer 1920.

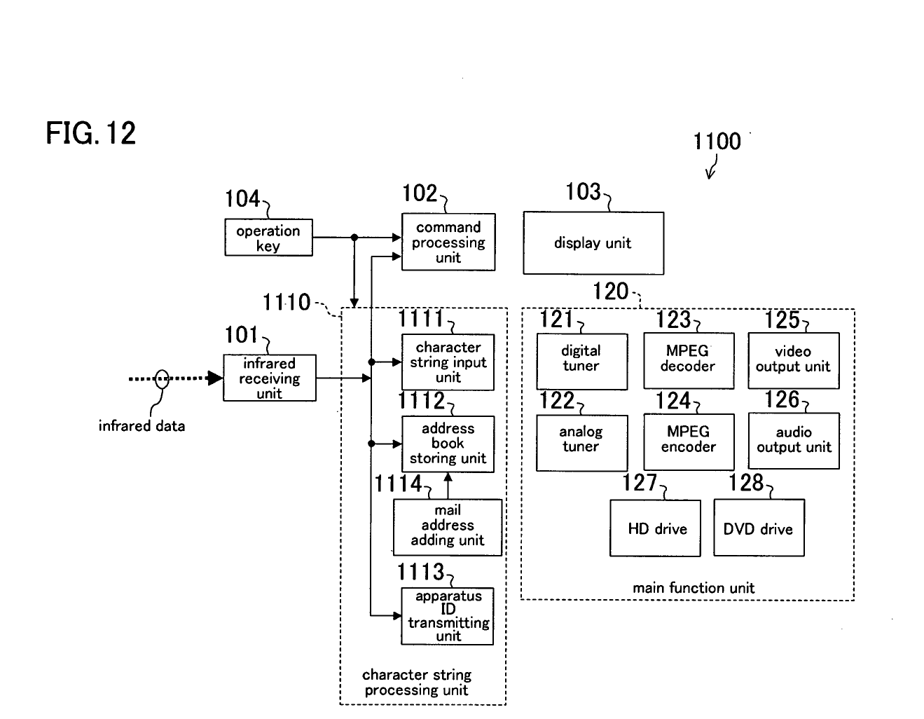

As shown in FIG. 12, a DVD recorder 1100 comprises a character string processing unit 1110 instead of the character string processing unit 110 of the DVD recorder 100 of Embodiment 1. An infrared receiving unit 101 and a character string processing unit 1110 of the DVD recorder 1100 are configured in a system LSI for a DVD recorder (content receiving terminal).

The character string processing unit 1110 comprises a character string input unit 1111 for inserting a character string indicated by infrared data received by the infrared receiving unit 101 into a character string displayed by the display unit 103 during a character string input state, an address book storing unit (name list storing unit) 1112 for storing an address book (name list) including an apparatus ID, an apparatus ID transmitting unit 1113 for transmitting an apparatus ID to the outside, and a mail address adding unit 1114 for adding a mail address to the address book.

The DVD recorder 1150 has the same configuration and function as those of the DVD recorder 1100. The DVD recorders 1100, 1150 and 1160 are connected to the Internet.

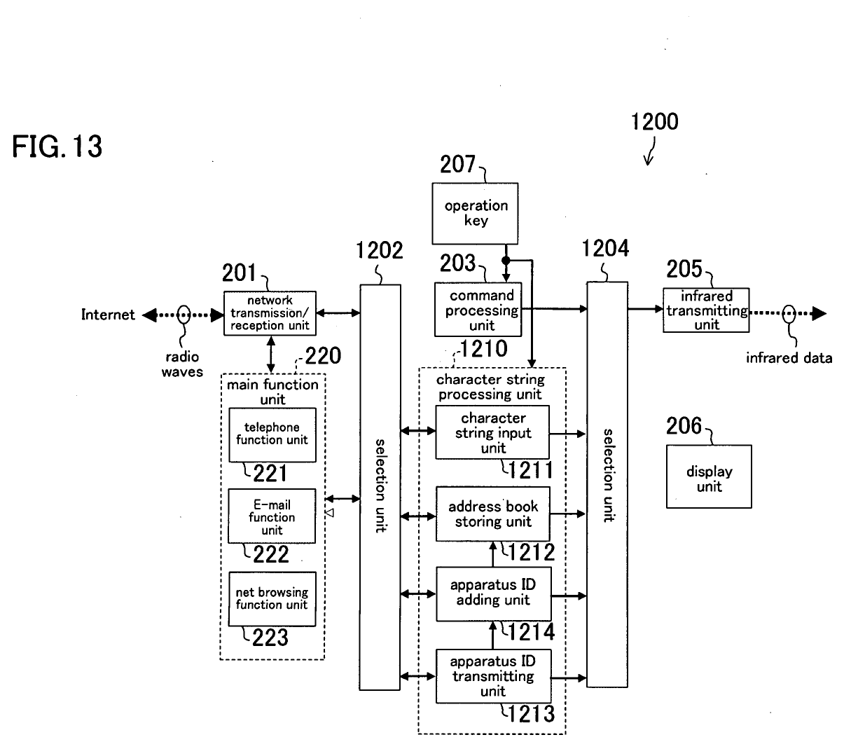

As shown in FIG. 13, the mobile telephone 1200 comprises a character string processing unit 1210 for processing an address book instead of the character string processing unit 210 of the mobile telephone 200 of Embodiment 1. The mobile telephone 1200 also comprises selection units 1202 and 1204 instead of the selection units 202 and 204. The network transmission/reception unit 201 and the character string processing unit 1210 of the mobile telephone 1200 are configured in a mobile telephone-specific system LSI.

The selection unit 1204 selects an address book output from the character string processing unit 1210, and transmits the address book to the infrared transmitting unit 205.

The selection unit 1202 selects and transmits an address book to the network transmission/reception unit 201 or the like as with the selection unit 1204.

The character string processing unit 1210 comprises a character string input unit 1211 for transmitting an address book to the outside, an address book storing unit (name list storing unit) 1212 for storing an address book (name list), an apparatus ID receiving unit 1213 for receiving an apparatus ID from the outside, and an apparatus ID adding unit 1214.

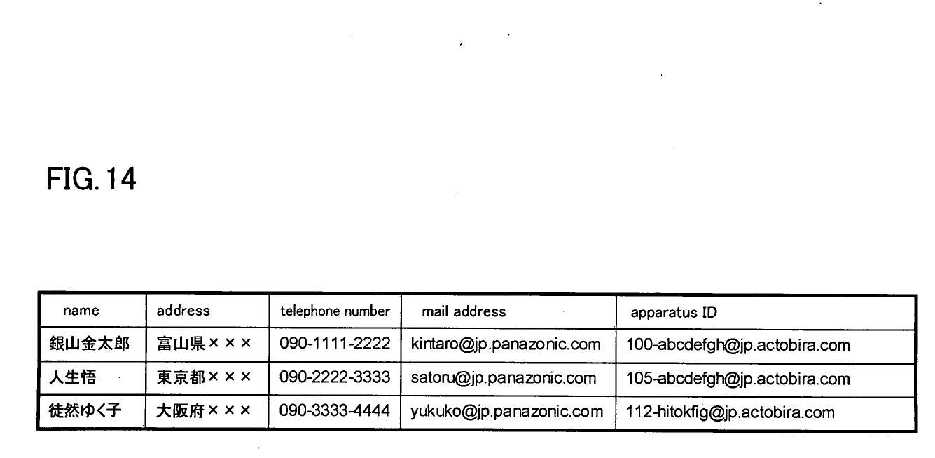

The address book storing unit 1112 of the DVD recorder 1100 and the address book storing unit 1212 of the mobile telephone 1200 each store an address book as shown in FIG. 14, for example. As shown in FIG. 14, the address book indicates a name, an address, a telephone number, a mail address, and an apparatus ID of a person in association with each other.

The personal computer 1920 and the DVD recorder 1160 also each comprise an address book storing unit for storing an address book.

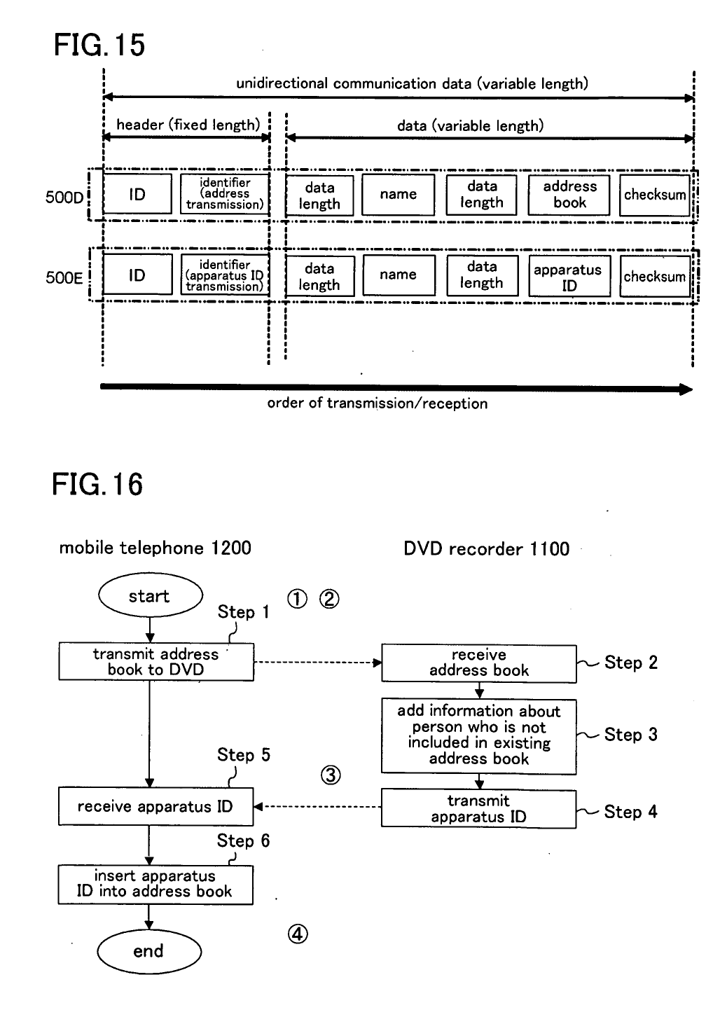

Infrared data that is received by the infrared receiving unit 101 of the DVD recorder 1100 via infrared communication has a format for unidirectional communication. Here, the unidirectional communication data format that is used for unidirectional communication of infrared will be described with reference to FIG. 15. Unidirectional communication data used here has a variable length.

A format 500D is used so as to transmit attribute data indicating an attribute of a person. The format 500D includes a header having a fixed length including an ID for identifying an individual apparatus and an identifier for indicating transmission of attribute data of one person, and data having a variable length including the data length of a name, name data indicating the name, the data length of the attribute data, the attribute data, and a checksum for checking a data error. Here, the attribute data includes data indicating a mail address and a mobile telephone number of a mobile telephone.

A format 500E is used so as to transmit an apparatus ID of one person. The format 500E includes a header having a fixed length including an ID for identifying an individual apparatus and an identifier for indicating transmission of an apparatus ID of one person, and data having a variable length including the data length of name data, the name data, the data length of the apparatus ID, the apparatus ID, and a checksum for checking a data error.

Here, an operation of the network system of this embodiment will be described.

Firstly, an operation in which the DVD recorder (second apparatus) 1100 and a mobile telephone (first apparatus) 1200 share an address book, will be described with reference to FIG. 16.

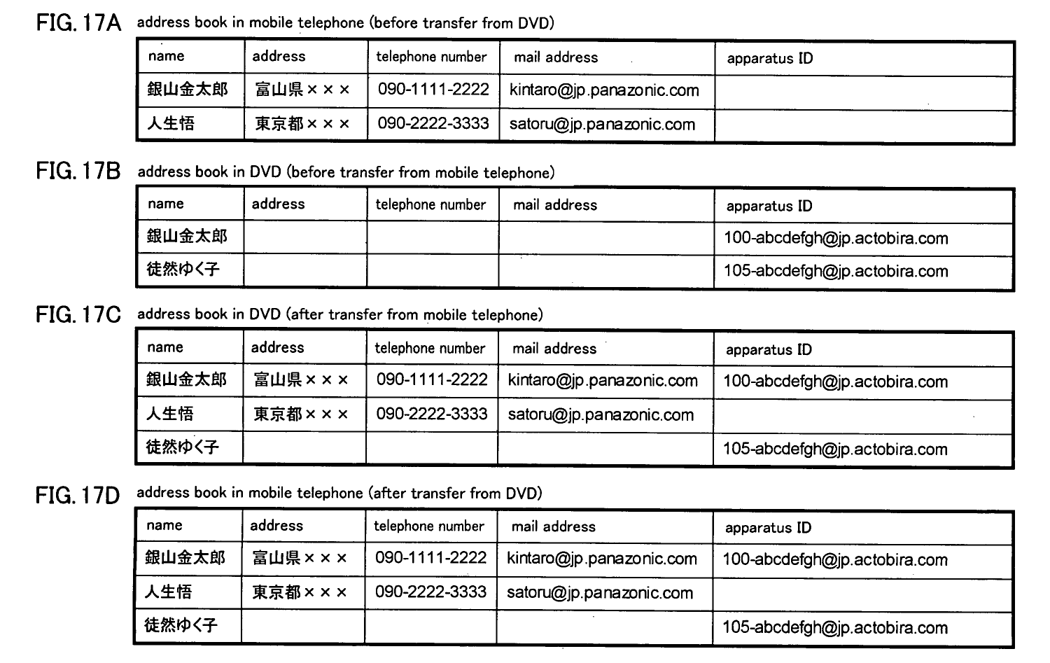

At the start of the operation of sharing an address book, a field for an apparatus ID is blank in an address book stored in the address book storing unit 1212 of the mobile telephone 1200 as show in FIG. 17A. Fields for an address, a telephone number and a mail address are blank in the address book stored in the address book storing unit 1112 of the DVD recorder 1100 as shown in FIG. 17B.

(Step 1) The infrared transmitting unit 205 of the mobile telephone 1200 transmits data indicating the contents of the address book to the DVD recorder 1100 via infrared communication.

(Step 2) The infrared receiving unit 101 of the DVD recorder 1100 receives the data indicating the contents of the address book from the mobile telephone 1200 via infrared communication.

(Step 3) The mail address adding unit 1114 of the DVD recorder 1100 adds the name, address, telephone number and mail address of a person in the address book indicated by the data received by the infrared receiving unit 101 in Step 2, whose name is not included in an existing address book stored in the address book storing unit 1112 of the DVD recorder 1100, to the existing address in association with each other. Further, the address, telephone number and mail address of a person included in both the address book indicated by the received data and the existing address book of the DVD recorder 1100, is inserted (added) into the existing address book in association with the name of the person.

When Step 3 is ended, the address book stored in the address book storing unit 1112 of the DVD recorder 1100 is as shown in FIG. 17C. Data of [symbol] that does not exist in FIG. 17B is added, and the address, telephone number and mail address fields that are blank in FIG. 17B are filled with data of [symbol] .

(Step 4) The apparatus ID transmitting unit 1113 of the DVD recorder 1100 transmits the name and apparatus ID of a person that are indicated in the address book stored in the address book storing unit 1112 in association with each other, to the mobile telephone 1200 in association with each other. This transmission is performed via infrared communication. The format of data to be transmitted is the format 500E of FIG. 15.

(Step 5) The apparatus ID receiving unit 1213 of the mobile telephone 1200 receives the data transmitted by the DVD recorder 1100 in Step 4, i.e., data indicating the name and apparatus ID of a person in association with each other, via infrared communication.

(Step 6) The apparatus ID adding unit 1214 inserts (adds) the name and apparatus ID of a person that are indicated in association with each other by the data received by the apparatus ID receiving unit 1213 in Step 5, into the address book stored in the address book storing unit 1212, in association with each other.

When Step 6 is ended, the mobile telephone address book is as shown in FIG. 17D. Data of [symbol] is added and has the same contents as those in the address book stored in the DVD recorder 1100 of FIG. 17C. By the above-described procedure, the address books stored in the DVD recorder 1100 and the mobile telephone 1200 are rewritten and therefore can be utilized in a new service.

Thus, in the network system (name list sharing system) of this embodiment, infrared data having a simple format is used, so that an address book can be shared by apparatuses, such as a television, a mobile telephone and the like, using low-cost communication means.

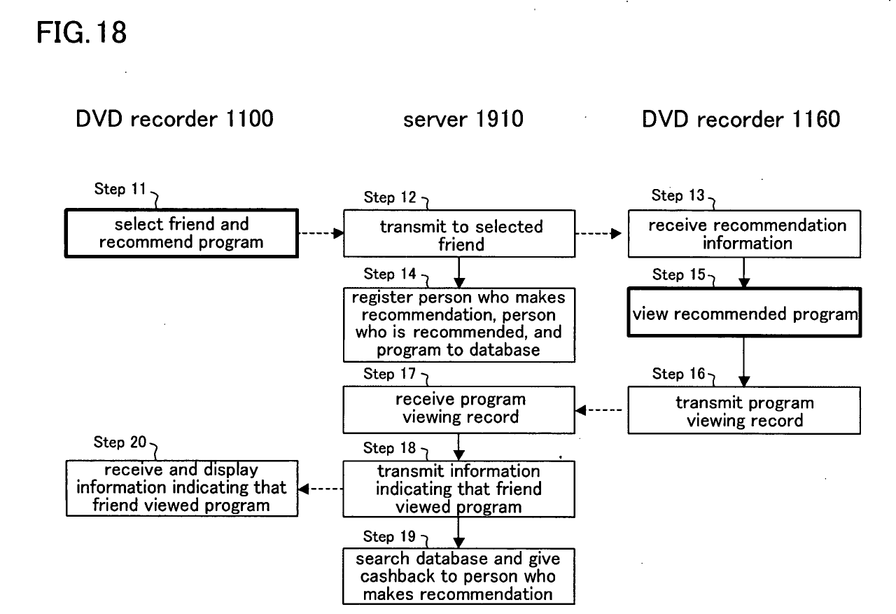

Next, an operation of the DVD recorders 1100 and 1160 when a new service is performed using an address book that is prepared by the procedure of FIG. 16, will be described with reference to a flowchart shown in FIG. 18. In the following operation, a user of a television connected to the DVD recorder (content information distributing apparatus) 1100 storing the address book of FIG. 17C, whose name is [symbol] recommends a program to his/her friend named [symbol] [symbol] is a user of the DVD recorder 1160 and a television (reception apparatus) connected thereto. The apparatus ID of the DVD recorder 1160 of [symbol] is registered in the address book stored in the DVD recorder 1100 of [symbol] [symbol] [symbol] is a pay broadcast that the viewer must pay 1500 yen to view.

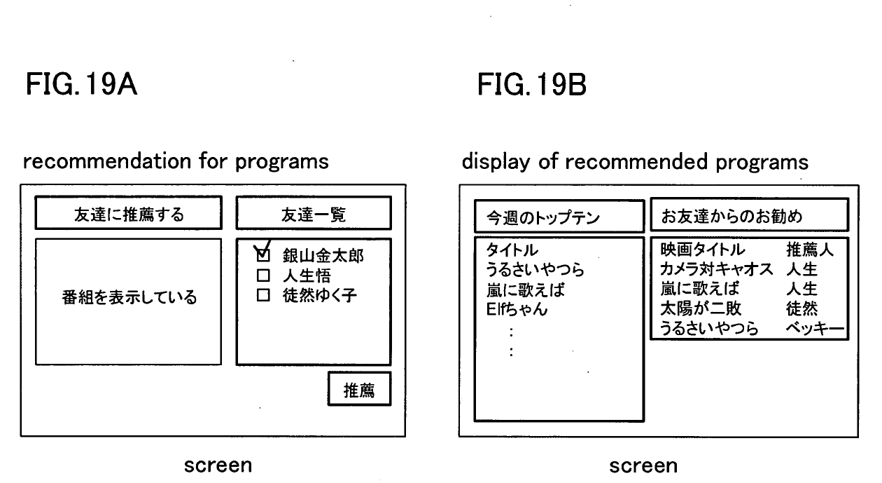

(Step 11) [symbol] when viewing a movie entitled [symbol] [symbol] on a television connected to the DVD recorder 1100, recommends [symbol] [symbol] to [symbol] Specifically, [symbol] when the DVD recorder 1100 is displaying a screen as shown in FIG. 19A on the television, performs a predetermined input to designate a button called [symbol] provided at a lower right portion of the screen with a checkbox adjacent to [symbol] being checked. Note that names that are displayed as a list of friends in the screen of FIG. 19A are names that are currently registered in the address book of the address book storing unit 1112. The predetermined input to designate the [symbol] button at the lower right portion of the screen, refers to pressing of a predetermined button on the remote controller while a cursor is placed on the [symbol] button, for example. A user to which recommendation information is to be transmitted may be designated by other input methods. When the predetermined input is performed, the DVD recorder 1100 transmits recommendation information (content information) that indicates a recommendation (designation) for the movie content entitled [symbol] [symbol] along with an apparatus ID “100-abcdefgh@jp.actobira.com” indicated in the address book in association with [symbol] via the Internet to the server 1910. In other words, the recommendation information is information indicating a recommended content.

(Step 12) The server 1910 receives the recommendation information transmitted by the DVD recorder 1100, and transmits the recommendation information to the DVD recorder 1160 whose user is [symbol] .

Specifically, in Steps 11 and 12, the DVD recorder 1100 transmits recommendation information to the DVD recorder 1160 having an apparatus ID indicated in an address book corresponding to the name of a person designated by the predetermined input, via the server 1910.

(Step 13) The DVD recorder 1160 receives the recommendation information transmitted by the server 1910 in (Step 12), and displays a content recommended by the received recommendation information on a television connected to the DVD recorder 1160. For example, on this television, a screen as shown in FIG. 19B is displayed as a top screen for providing a new service that distributes moving images. In the screen of FIG. 19B, a left half portion thereof displays [symbol] [symbol] and a right half portion thereof displays [symbol] [symbol] In the right half portion, [symbol] [symbol] recommended by [symbol] is displayed in accordance with the recommendation information from the DVD recorder 1100. Note that the DVD recorder 1160 and a television connected to the DVD recorder 1160 constitute a reception apparatus.

(Step 14) The server 1910 registers, into a database, a recommendation of [symbol] for [symbol] [symbol] to [symbol] .

When [symbol] views [symbol] [symbol] Steps 15 to 20 described below are executed.

(Step 15) [symbol] views [symbol] [symbol] which is a recommended program.

(Step 16) The DVD recorder 1160 transmits a program viewing record indicating that [symbol] [symbol] recommended by [symbol] was viewed by [symbol] to the server 1910.

(Step 17) The server 1910 receives the program viewing record transmitted by the DVD recorder 1160 in Step 16.

(Step 18) The server 1910 transmits the program viewing record received in Step 17 to the DVD recorder 1100.

(Step 19) The server 1910 searches the database based on the program viewing record, and if finding the information registered in Step 14 (i.e., information about recommendation of [symbol] for [symbol] [symbol] to [symbol] performs a process of allowing [symbol] to get ¥50 cashback.

(Step 20) When [symbol] uses the DVD recorder 1100 after the process of Step 19, the DVD recorder 1100 displays information indicating that [symbol] viewed [symbol] [symbol] on a screen of a television connected to the DVD recorder 1100.

As described above, it is normally necessary to pay ¥1500 to view [symbol] [symbol] and if [symbol] views it on the recommendation of [symbol] [symbol] gets ¥50 cashback. Thus, the popularity of pay moving image contents can be promoted by providing a financial incentive to viewing depending on the recommendation of another apparatus.

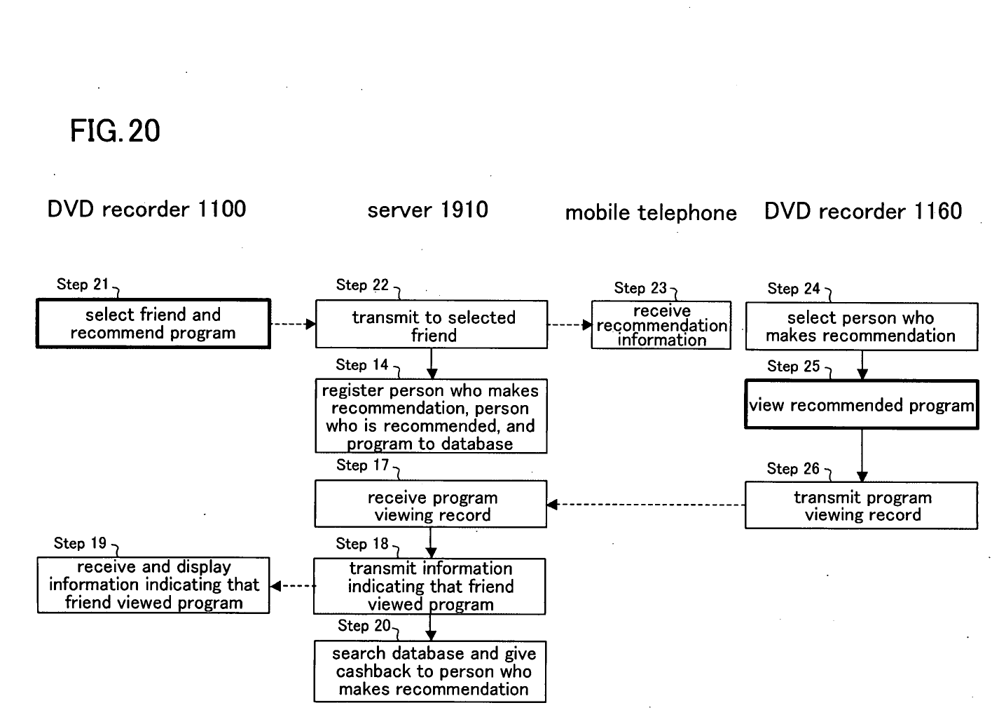

An operation of the DVD recorder 1100 and 1160 when another new service is performed will be described with reference to a flowchart shown in FIG. 20. Note that steps having the same operations as those of the flowchart of FIG. 18 are indicated by the same symbols and will not be described. In the flow of FIG. 20, [symbol] who is a user of a television connected to the DVD recorder 1100 that stores the address book of FIG. 17C, recommends a program to his/her friend named [symbol] In the address book of the DVD recorder 1100, the mobile telephone address of [symbol] is registered, but not the apparatus ID. It is also here assumed that a user of a television connected to the DVD recorder 1160 is

[symbol]

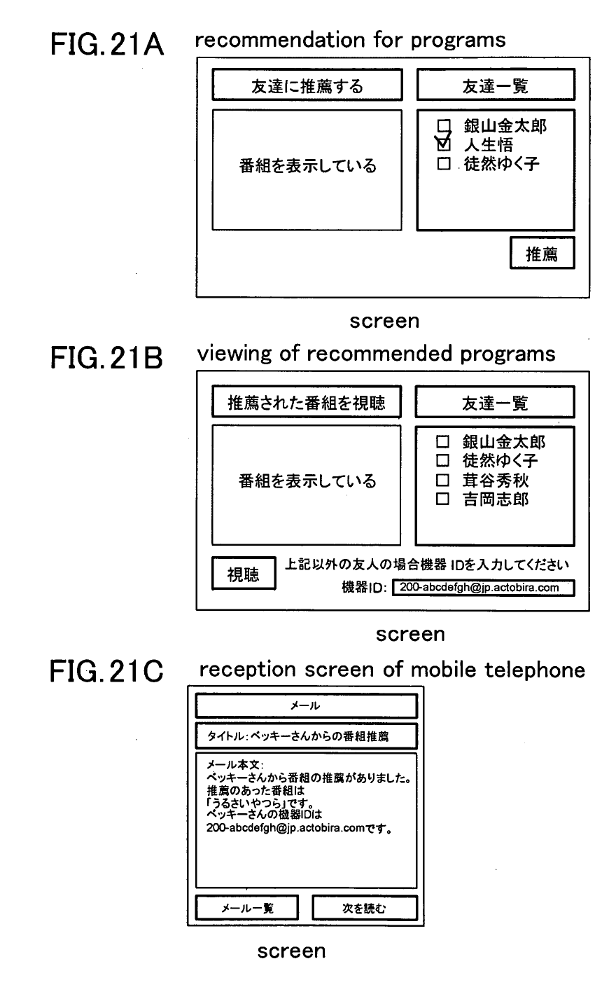

(Step 21) [symbol] when viewing the movie entitled [symbol] [symbol] on the television connected to the DVD recorder 1100, recommends [symbol] [symbol] to [symbol] [symbol] . A method for designating a user to be recommended is similar to that of Step 11. Specifically, while the DVD recorder 1100 displays a screen as shown in FIG. 21A on the television (i.e., a checkbox adjacent to [symbol] is checked), [symbol] performs a predetermined input to designate a button named [symbol] provided at a lower right portion of the screen. In Step 11, recommendation information is transmitted along with an apparatus ID “100-abcdefgh@jp.actobira.com” corresponding to a user to be recommended, to the server 1910. Here, as shown in FIG. 17C, an apparatus ID corresponding to [symbol] is not recorded in the address book of the DVD recorder 1100, and therefore, the DVD recorder 1100 transmits, instead of the apparatus ID, the mail address “satoru@jp.panazonic.com” of the mobile telephone (mail receiving terminal) and the apparatus ID of the DVD recorder 1100 itself to the server 1910.

(Step 22) The server 1910 transmits recommendation information about recommendation (designation) of a movie content entitled [symbol] [symbol] to the mobile telephone of [symbol] and the apparatus ID of the DVD recorder 1100 using the mail address of [symbol] transmitted by the DVD recorder 1100 in Step 21.

Specifically, in Steps 21 and 22, the DVD recorder 1100 transmits recommendation information and the apparatus ID of the DVD recorder itself transmitting the recommendation information, via the server 1910, to a mobile telephone having a mail address indicated in an address book corresponding to the name of a person designated by the predetermined input.

(Step 23) The mobile telephone of [symbol] receives the recommendation information transmitted by the server 1910 in Step 22. Thereafter, the mobile telephone displays a screen as shown in FIG. 21B. This screen displays the apparatus ID of a person who makes a recommendation and a recommended program.

When [symbol] views [symbol] [symbol] Steps 24 to 26 described below will be executed.

(Step 24) [symbol] inputs the apparatus ID of [symbol] who makes a recommendation and is displayed on the screen of the mobile telephone in Step 23, to the DVD recorder 1160 by a remote controller operation or the like while viewing the screen. After the apparatus ID is input, a television connected to the DVD recorder 1160 displays the input apparatus ID in an apparatus ID field at a lowermost portion of the screen, as shown in a screen of FIG. 21C.

(Step 25) While a screen as shown in FIG. 21C is displayed, [symbol] performs a predetermined input to designate a [symbol] button at a lower left portion of the screen. Here, the predetermined input to designate the [symbol] button at the lower left portion of the screen, refers to pressing of a predetermined button of a remote controller while a cursor is placed on the [symbol] button, for example. A program viewing record may be transmitted by other input methods.

(Step 26) The DVD recorder 1160 transmits a program viewing record indicating that [symbol] viewed [symbol] [symbol] recommended by [symbol] to the server 1910, depending on the predetermined input in Step 25.

Thus, since a DVD recorder and a mobile telephone share the contents of an address book, a user of the DVD recorder can transmit a mail as shown in the screen of FIG. 21B to his/her friend whose apparatus ID is not originally registered in the DVD recorder. The friend receiving the mail can receive a service, such as cashback or the like, by inputting an apparatus ID to the DVD recorder when a screen on which the recommended program is displayed as shown in the screen of FIG. 21C is displayed on a television connected to his/her own DVD recorder with the apparatus ID field being blank.

Another exemplary service is described as follows. When a user of the DVD recorder 1100 performs a predetermined input operation, a commodity product of a commercial may be delivered to an address indicated by an address book stored in the DVD recorder. Thereby, the value of a commercial can be improved.

Note that, instead of the DVD recorder 1100, the configuration of FIG. 12 may be provided in other content receiving terminals, such as a television broadcast receiving device and the like.

It has also been described above that the address book stored in each of the address book storing unit 1112 of the DVD recorder 1100 and the address book storing unit 1212 of the mobile telephone 1200 indicates an address, a telephone number and a mail address as personal attributes. Instead of this address book, a name list indicating a portion of these attributes or other attributes may be used.

Also, in Embodiments 1 and 2, unidirectional communication other than infrared may be performed.

As described above, according to the character string receiving device, the character string transferring device, and the character string transmitting/receiving system of the present invention, a user's dictionary or a registered word can be shared by a plurality of apparatus while reducing the cost, and a character string of the Japanese language or the like can be more easily input to a video apparatus, an audio apparatus or the like while reducing the cost. For example, the present invention is useful as a technique of sharing information among a plurality of apparatuses by transferring information bidirectionally or unidirectionally.

Also, according to the content receiving terminal-specific system LSI, the name list sharing system, the name list sharing method, and the content recommending method of the present invention, the promotion of viewing of moving images distributed on the Internet can be facilitated. For example, the present invention is useful as a technique of sharing information among a plurality of apparatuses by transferring information bidirectionally or unidirectionally.

What is claimed is:

1. A character string receiving device comprising:
a reception unit for receiving character string data indicating a character string via unidirectional communication; and
a character string processing unit for processing the character string data received by the reception unit.

2. The character string receiving device of claim 1, wherein
the reception unit receives the character string data via infrared communication.

3. The character string receiving device of claim 1, wherein
the character string data indicates at least one first character string and at least one second character string in association with each other; and
the character string processing unit includes a user's dictionary storing unit for storing a user's dictionary for use in kana-to-kanji conversion, and registers the first and second character strings indicated by the character string data into the user's dictionary stored in the user's dictionary storing unit, as character strings before and after the conversion, in association with each other.

4. The character string receiving device of claim 1, further comprising:
a display unit for displaying a character string, wherein the character string displayed by the display unit can be edited by a user,
wherein the character string processing unit inserts the character string indicated by the character string data into the character string displayed by the display unit that is being edited.

5. The character string receiving device of claim 1, wherein
the reception unit further receives a command for instructing the character string receiving device to perform an operation corresponding to an input operation of a user.

6. The character string receiving device of claim 1, wherein
the character string processing unit includes a registered word storing unit for recording a list of registered words, or the character string receiving device includes a display unit for displaying a character string,
the character string data is character string data for a user's dictionary indicating character strings before and after kana-to-kanji conversion in association with each other, and
the character string processing unit registers one of the character strings before and after the conversion indicated by the character string data, into the list stored in the registered word storing unit, or inserts a character string displayed by the display unit.

7. The character string receiving device of claim 1, wherein
the character string processing unit includes a registered word storing unit for recording a list of registered words, or the character string receiving device includes a display unit for displaying a character string,
the character string data is character string data for a user's dictionary indicating character strings before and after kana-to-kanji conversion in association with each other,
the character string processing unit includes a user's dictionary storing unit for storing a user's dictionary for use in kana-to-kanji conversion, and operates in a plurality of modes including a user's dictionary registration mode,
the character string processing unit, when operating in the user's dictionary registration mode, registers the character strings before and after the conversion indicated by the character string data, into the user's dictionary stored in the user's dictionary storing unit, and
the character string processing unit, when operating in a mode other than the user's dictionary registration mode, registers one of the character strings before and after the conversion indicated by the character string data, into the list stored in the registered word storing unit, or inserts one of the character strings before and after the conversion indicated by the character string data, into a character string displayed by the display unit.

8. A character string transferring device comprising:
a transmission/reception unit for transmitting and receiving transmission/reception character string data indicating a character string via bidirectional communication; and
a transmission unit for transmitting transmission character string data indicating a character string via unidirectional communication.

9. The character string transferring device of claim 8, further comprising:
a user's dictionary storing unit for storing a user's dictionary for registering character strings before and after kana-to-kanji conversion in association with each other,
wherein the transmission character string data indicates the character strings before and after the conversion registered in the user's dictionary.

10. The character string transferring device of claim 8, wherein
the transmission/reception unit transmits and receives the transmission/reception character string data using a telephone line or a LAN line.

11. The character string transferring device of claim 8, wherein
the transmission unit transmits the transmission character string data via infrared communication.

12. A character string transmitting/receiving system comprising:
the character string transferring device of claim 8; and
the character string receiving device of claim 1,
wherein the reception unit of the character string receiving device receives the transmission character string data transmitted by the transmission unit of the character string transferring device,
the character string transferring device further includes a user's dictionary storing unit for storing a user's dictionary for registering character strings before and after kana-to-kanji conversion in association with each other, and
the transmission character string data indicates the character strings before and after the conversion registered in the user's dictionary.

13. A content receiving terminal-specific system LSI for use in a content receiving terminal capable of transmitting content information about a recommended content and an apparatus ID of the content receiving terminal to a mail receiving terminal having a mail address, the content receiving terminal-specific system LSI comprising:
a name list storing unit for storing a name list indicating a name and an apparatus ID of a person in association with each other;
an infrared receiving unit for receiving data indicating a content of a name list indicating a name and a mail address of a person in association with each other, via infrared communication; and
a mail address adding unit for adding a name and a mail address of a person whose name is not included in the name list stored in the name list storing unit, of the name list indicated by data received by the infrared receiving unit, to the name list stored in the name list storing unit in association with each other, and further adding a mail address of a person whose name is included in the name list stored in the name list storing unit, of the name list indicated by the data, to the name list stored in the name list storing unit, in association with the name of the person.

14. A name list sharing system comprising:
the content receiving terminal-specific system LSI of claim 13; and
a mobile telephone-specific system LSI including a name list storing unit for storing a name list indicating a name and a mail address of a person in association with each other, and an infrared transmitting unit for transmitting data indicating a content of the name list stored in the name list storing unit, to a content receiving terminal including the content receiving terminal-specific system LSI, via infrared communication.

15. A name list sharing method comprising:
a first step in which a first apparatus having a name list storing unit for storing a first name list indicating a name and a mail address of a person in association with each other, transmits data indicating a content of the first name list via infrared communication;
a second step in which a second apparatus having a name list storing unit for storing a second name list indicating a name and an apparatus ID of a person in association with each other and capable of transmitting content information indicating a recommended content and an apparatus ID of the second apparatus, to a mail receiving terminal having a mail address, receives the data transmitted by the first apparatus in the first step; and
a third step in which the second apparatus adds a name and a mail address of a person whose name is not included in the second name list, of the first name list indicated by the data received in the second step, to the second name list in association with each other, and further adds a mail address of a person whose name is included in the second name list, of the first name list, to the second name list in association with the name of the person.

16. The name list sharing method of claim 15, further comprising:
a fourth step in which the second apparatus transmits a name and an apparatus ID of a person indicated by the second name list in association with each other, to the first apparatus via infrared communication;
a fifth step in which the first apparatus receives the data transmitted by the second apparatus in the fourth step; and
a sixth step in which the first apparatus adds the name and apparatus ID of the person indicated by the data received in the fifth step in association with each other, to the first name list in association with each other.

17. A content recommending method comprising:
a first step in which a content information distributing apparatus having a name list storing unit for storing a name list indicating a name and an apparatus ID of a person in association with each other, transmits content information indicating a recommended content to a content receiving terminal having an apparatus ID indicated by the name list in association with a name of a person designated by an input; and
a second step in which the content receiving terminal receives the content information transmitted in the first step, and displays the recommended content indicated by the received content information.

18. A content recommending method comprising:
a first step in which a content information distributing apparatus having a name list storing unit for storing a name list indicating a name and a mail address of a person in association with each other, transmits content information indicating a recommended content designated by an input and an apparatus ID of the content information distributing apparatus, to a mail receiving terminal having a mail address indicated by the name list in association with a name of a person designated by an input; and
a second step in which the mail receiving terminal receives the content information and the apparatus ID transmitted in the first step, and displays the recommended content indicated by the received content information and the apparatus ID.
